(19) United States
(12) Patent Application Publication
(10) Pub. No.: US 2026/0211077 A1
(43) Pub. Date: Jul. 23, 2026

(54) WAVEGUIDE ANTENNA, RADAR SENSOR AND VEHICLE

(71) Applicant: Continental Autonomous Mobility Germany GmbH, Ingolstadt (DE)

(72) Inventors: Johannes Kammerer, Lindau (DE); Richard Wedlich, München (DE); Simon Holzner, Hettenshausen (DE)

(73) Assignee: Continental Autonomous Mobility Germany GmbH, Ingolstadt (DE)

(21) Appl. No.: 19/134,939

(22) PCT Filed: Nov. 20, 2023
(86) PCT No.: PCT/DE2023/200229

§ 371 Date: Jun. 2, 2025

(30) Foreign Application Priority Data
Dec. 2, 2022 (DE) 10 2022 213 016.2
Nov. 14, 2023 (DE) 10 2023 211 324.4

(51) Int. Cl. G01S 7/03; G01S 13/931

(52) U.S. Cl. CPC G01S 7/032; G01S 13/931

(57) ABSTRACT

A waveguide antenna, in particular for a radar sensor is disclosed, including at least two adjacent radiator elements for transmitting and/or receiving signals. Each radiator element has a surrounding wall that forms a cavity. A central axis extends through the cavity, and the wall of at least one of the radiator elements is tilted relative to the central axis of the radiator element as viewed in a cross-section of the H-plane.

### CROSS-REFERENCE TO RELATED APPLICATIONS

The present application is a National Stage Application under 35 U.S.C. § 371 of International Patent Application No. PCT/DE 2023/200229 filed on Nov. 20, 2023, and claims priority from German Patent Application No. 10 2022 213 016.2 filed on Dec. 2, 2022, and German Patent Application No. 10 2023 211 324.4 filed on Nov. 14, 2023, in the German Patent and Trademark Office, the disclosures of which are herein incorporated by reference in their entireties

### TECHNICAL FIELD

The present invention relates to a waveguide antenna for a radar sensor, a corresponding radar sensor for a vehicle as well as a vehicle which has a radar sensor according to the invention.

### BACKGROUND

Modern means of transportation such as motor vehicles or motorcycles are increasingly being equipped with driver assistance systems which, with the aid of sensor systems, can capture the surroundings, recognize traffic situations and support the driver, e.g., by a braking or steering intervention or by outputting a visual or audible warning. Radar sensors, lidar sensors, camera sensors or the like are regularly deployed as sensor systems for capturing the surroundings. Conclusions can subsequently be drawn about the surroundings from the sensor data established by the sensors. The capturing of the surroundings by means of radar sensors is based on the emission of bundled electromagnetic waves and the reflection thereof, e.g., by other road users, obstacles on the road or the peripheral development of the road.

The capturing of pedestrians is often carried out with camera sensors, but radar sensors are being increasingly deployed in this case as well.

The radar sensors deployed for systems of the type described above are frequently also used in fusion with other technology's sensors such as, e.g., camera or lidar sensors. The advantage of radar sensors, inter alia, is that they work reliably even in poor weather conditions and, in addition to the distance of objects, they can also directly measure the radial relative speed thereof via the Doppler effect. As a general rule, 24 GHZ, 77 GHz and 79 GHz are deployed as transmitting frequencies.

Due to the increasing functional scope of such systems, the requirements, in particular in terms of the maximum detection range, are constantly increasing. In addition to capturing the surroundings of motor vehicles for systems of the type described above, the focus is now also turning toward monitoring the interior of motor vehicles, e.g., in order to recognize which seats in the vehicle are occupied; frequencies in the range of 60 Hz, e.g., are deployed.

In the case of modern radar sensors, the design of the antenna or of the antenna architecture is of particular importance, wherein the radiation characteristic of the antenna (i.e., substantially intensity, field strength, polarization, phase, transit time differences and the like) must be observed to a particular extent. In this case, the radiation characteristic of an antenna (intensity, field strength, polarization, phase, transit time differences) can be depicted graphically in an antenna diagram which is a type of spatial coordinate system. Such antenna diagrams can be generated by measurement or simulation in order to depict the directivity of the antenna. In the antenna diagram, the directional characteristic can be depicted for various directions, e.g., in the case of a horizontal antenna diagram, mostly in polar coordinates with the antenna at the center (i.e., a type of horizontal section through the three-dimensional diagram). Regions of the antenna diagram or maxima which are delimited by relative minima are referred to as so-called lobes according to their appearance. The main lobe is the global maximum and contains the main radiation direction of the antenna. By contrast, so-called side lobes are pronounced local maxima which contain (in particular, unwanted) radiation in a direction other than the main radiation direction. In addition, back lobes, i.e., a side lobe arranged directly or broadly opposite the main lobe, or grating lobes, i.e., periodically occurring strong side lobes, can occur. Since unwanted radiation effects can be caused by side lobes, there is a particular interest in minimizing or suppressing such side lobes.

So-called waveguide antennas are often deployed in modern radar sensors. In this case, slot radiators and horn radiators are predominantly deployed, in which the individual radiator elements (slot radiators/horns or the like) mostly have a mold release slope (e.g., in the shape of a pyramid, or conical), which is predominantly realized similarly in the case of the radiator elements. The antennas have side lobes predominantly at larger elevation angles of up to MBD—10 dB.However, reflections can occur in the installation location in the vehicle, as a result of which the antenna experiences an angle of incidence due to multipath reception at higher elevation angles. This is, for example, an unwanted radiation effect since the angular range is not part of the signal processing and is consequently superimposed on the actual signal as disturbance noise. As a consequence, the signal-to-noise ratio (SNR) falls and the antenna gain is worsened. As a general rule, the directivity and the efficiency of an antenna are combined under the antenna gain, wherein this indicates the ratio of the radiation power density of an antenna emitted or received (in the main direction) and an idealized, zero-loss reference antenna of the same antenna feed power, i.e., for example has an antenna gain of 0 dB. The antenna gain (in dB) can be indicated as a function of the angle at which the radar radiation is emitted or received.

In the case of the waveguide or the individual radiator elements, the electric and magnetic fields of electromagnetic waves are always perpendicular to one another. The states of the waveguide can be referred to as vibrational modes, wherein H-modes are understood to mean when the electric field is perpendicular to the direction of propagation of the electromagnetic waves, and E-modes are understood to mean when the magnetic field is perpendicular to the direction of propagation of the electromagnetic waves. The E-plane, like the so-called H-plane, is a reference plane for linearly polarized waveguides, antennas and the like. In the case of a linearly polarized antenna, the E-plane is the plane which contains the electric field vector (also referred to as the E-aperture) and the direction of the maximum radiation. In this case, the electric field or the E-plane determines the polarization or alignment of the radio wave. As a general rule, in the case of a vertically polarized antenna, the E-plane corresponds to the vertical/height plane. As a general rule, in the case of a horizontally polarized antenna, the E-plane corresponds to the horizontal/azimuthal plane. However, the E-plane and the H-plane should constantly be 90 degrees apart from one another or perpendicular to one another. In the case of a linearly polarized antenna, the H-plane is the plane which contains the magnetic field vector (sometimes also called the H-aperture) and the direction of the maximum radiation. The magnetization field or the H-plane lies at a right angle to the E-plane. In the case of a vertically polarized antenna, the H-plane coincides with the horizontal/azimuthal plane. As a general rule, in the case of a horizontally polarized antenna, the H-plane coincides with the vertical/elevation plane.

An antenna system for radar sensors is known from DE 10 2010 041 438 A1, which operates with low loss and makes possible effective suppression of side lobes in that the antenna system has a group antenna with at least two antenna gaps which extend parallel to one another, wherein the antenna gaps are connected to one another at one end via a bypass line, the length of which is dimensioned such that the antenna gaps are in phase with one another overall. To this end, the group antenna has a feed line into which multiple antenna elements configured as patches are integrated, and forms two parallel antenna gaps which extend vertically in the installation position, which are connected to one another at one end by the bypass line.

Furthermore, a radar sensor for a motor vehicle having a radome, a circuit board and having at least one antenna element is known from EP 3 336 575B1, wherein the antenna element includes a dielectric resonator which is formed by a part of the radome, and has a slot antenna for feeding straight, squarely configured dielectric resonators or antenna elements. The slot antenna is configured in the circuit board. In particular, the radar sensor can also have a multiplicity of antenna elements which are arranged in a so-called array along a line, as a result of which the antenna gain is increased and the radiation behavior can be bundled in the elevation direction. Furthermore, a high side lobe suppression in the elevation direction is achieved by the embodiment.

Moreover, DE 11 2017 001 257 T5 discloses an antenna array which has a conductive member having first and second slots which are adjacent to one another. The conductive surface on a front side of the conductive member is shaped so as to define first and second horns which each communicate with the first and second slots. The respective E-planes of the slots lie on the same plane or on a plurality of planes which are substantially parallel to one another. In an E-plane cross-section of the first horn, a length from one of two intersections between the E-plane and an edge of the first slot to one of two intersections between the E-plane and an edge of the aperture plane of the first horn is longer than a length from the other intersection between the E-plane and the edge of the first slot to the other intersection between the E-plane and the edge of the aperture plane of the first horn, wherein the lengths run along an inner wall surface of the first horn. Accordingly, the vertically polarized radiators or horns are asymmetrical or can be tilted as viewed in the cross-section of the E-plane, in order to achieve suppression of the side lobes.

Furthermore, Moradian et al. in “Planar Slotted Array Antenna Fed by Single Wiggly-Ridge Waveguide” (IEEE ANTENNAS AND WIRELESS PROPAGATION LETTERS, VOL. 10, 2011) describe a planar antenna array having centered longitudinal slots which are fed by a single wiggly line-shaped waveguide.

Starting from the prior art, the problem of the present disclosure is now to make available a waveguide antenna and a generic radar sensor, with which an improvement of the antenna gain or single radiator gain can be attained in a simple and cost-effective manner.

The aforementioned problem is solved by the entire teaching of Claim 1 as well as the alternative, independent claims. Expedient embodiments of the present disclosure are claimed in the subclaims.

The waveguide antenna according to the present disclosure is in particular provided for a radar sensor, e.g., in the field of automotive radar sensors, and includes at least two adjacent radiator elements which, together, can form a single radiator characteristic and serve to transmit and/or receive radar signals or HF signals. Furthermore, each radiator element has a surrounding wall that forms a cavity, wherein a central axis or median axis extends through the cavity. The central axis is the middle axis lying (perpendicularly) in the center of the radiator element, which at the same time represents an axis of symmetry, i.e., a center line around which the body or the wall of the radiator element is arranged rotationally symmetrically. Rotationally symmetrical within the meaning of the present disclosure is understood to mean that the radiator element (in a top view) can be imaged onto itself when it is rotated by a certain angle of rotation of less than 360° or less than or equal to 180°, i.e., it is unchanged in the sectional image. If the body or the radiator element (in a top view) is only symmetrical with respect to rotations of 360°, this is not understood to be rotationally symmetrical within the meaning of the present disclosure. Furthermore, the wall of at least one of the radiator elements is tilted relative to the central axis of the radiator element, i.e., the radiator element is tilted toward the phase center of the waveguide antenna, as viewed in the cross-section of the H-plane. In this case, the term tilt is to be understood to mean that the wall of the radiator element is brought into an oblique position at least on one side (or partially) or an existing oblique position is intensified so that the radiator element tilts (or tilts more) (in particular in cross-section). The tilted radiator element is no longer rotationally symmetrical due to the tilt relative to the original central axis (i.e., the central axis of the radiator element without tilting), in particular in a top view. The tilting according to the present disclosure of the radiator elements as viewed in the cross-section of the H-plane results in a higher signal-to-noise ratio, since the gain is lowered at higher elevation angles. The sensor is therefore less interference-prone. Furthermore, an improvement of the antenna gain or single radiator gain can consequently be attained. This can already be achieved simply with a small number of radiator elements. Surprisingly, it has been shown that a tilt can be carried out as viewed in the cross-section of the H-plane, including in particular without providing a tilt of the radiator elements as viewed in the cross-section of the E-plane, since the radiator elements are symmetrical as viewed in the cross-section of the E-plane and consequently are not tilted. By tilting the radiator elements as viewed in the cross-section of the H-plane, not only can the main lobes be improved and the side lobes reduced or decreased or suppressed, but the characteristic between the main and side lobes can also be influenced, which leads to a more homogeneous distribution of the radiated or received power and can be adjusted specifically for a particular application (e.g., in the long-range or short-range radar) for the following signal processing and/or can be advantageous.

### SUMMARY

According to an example embodiment of the present disclosure, the waveguide antenna can be a slot antenna, a horn antenna or an OEWG (Open Ended Wave Guide) antenna, wherein the single radiators or radiator elements are arranged at openings or slots of the antenna.

The radiator elements can be expediently tilted symmetrically relative to the center of the waveguide antenna as viewed in the cross-section of the H-plane.

For example, the radiator elements can be tilted toward the center of the waveguide antenna on both sides of the center of the waveguide antenna or can be tilted away from the center of the waveguide antenna on both sides of the center of the waveguide antenna. As a result, the antenna gain can be improved even further.

Alternatively, the radiator elements or some of the radiator elements can also be arranged/oriented without any specific symmetry or alignment relative to one another (i.e., randomly or pseudo-randomly).

Furthermore, the tilted radiator elements can be tilted symmetrically, in particular mirror-symmetrically, relative to the center of the waveguide antenna as viewed in the cross-section of the H-plane (i.e., the individual radiator elements are indeed asymmetrical as viewed in the cross-section of the H-plane, but, for example, all of the radiator elements on one side of the waveguide antenna are tilted equally in the same direction).

The tilted radiator elements may be tilted toward the center of the waveguide antenna on both sides of the center of the waveguide antenna or tilted away from the center of the waveguide antenna on both sides of the center of the waveguide antenna as viewed in the cross-section of the H-plane. The side lobe suppression and the antenna gain can be increased even further by the individual designs of the tilts.

Alternatively, all of the tilted radiator elements can also be tilted in the same direction as viewed in the cross-section of the H-plane, as a result of which a particular radiation characteristic can be attained with an increased antenna gain.

The radiator elements can also be tilted at the same tilt angle (which is arranged between the tilted wall and the plane of the antenna) as viewed in the cross-section of the H-plane. Alternatively, they can also only partially have the same tilt angle or have different tilt angles.

According to a particular embodiment of the present disclosure, the radiator elements can have a form which widens on one side, in particular a form which widens conically or pyramidally in the transmission direction (i.e., away from the antenna), or a straight form.

The radiator elements can be expediently arranged such that the central axes thereof are arranged along a curved, in particular serpentine, line, i.e., in this case, the individual slots can be of different sizes and can be displaced laterally relative to one another. Alternatively, the slots or the central axes of the radiator elements can also be arranged on a straight line. Surprisingly, the side lobe suppression can be improved even further due to the special arrangement of the radiator elements along a curved line.

Furthermore, the present disclosure includes a radar sensor, in particular for recognizing objects for a vehicle, having a high-frequency component for generating and/or receiving HF signals or radar signals and a waveguide antenna according to the present disclosure for coupling in and/or coupling out the radar signals or HF signals.

In addition, the present disclosure claims a motor vehicle or vehicle which has a radar sensor according to the present disclosure.

### BRIEF DESCRIPTION OF THE DRAWINGS

The present disclosure is explained in greater detail below with reference to expedient example embodiments, wherein:

FIG. 1 shows a simplified schematic representation of a waveguide antenna as viewed in the cross-section of the H-plane according to the prior art;

FIG. 2 shows a simplified schematic representation of an embodiment of a waveguide antenna according to the present disclosure as viewed in the cross-section of the H-plane;

FIG. 3 shows a simplified schematic representation of a further embodiment of a waveguide antenna according to the present disclosure as viewed in the cross-section of the H-plane;

FIG. 4 shows a simplified schematic top view representation of the embodiment of the waveguide antenna according to the prior art from FIG. 1;

FIG. 5 shows a simplified schematic top view representation of the embodiment of the waveguide antenna according to the present disclosure from FIG. 2; FIG. 6 shows a simplified schematic top view representation of the embodiment of the waveguide antenna according to the present disclosure from FIG. 3; FIG. 7 shows a simplified representation of the resulting antenna gain in elevation of the waveguide antenna from FIG. 2 (solid line) and of the waveguide antenna from FIG. 1 (dashed line) [frequency 78.5 GHZ; θ80=90°];

FIG. 8 shows a simplified representation of the resulting antenna gain in azimuth of the waveguide antenna from FIG. 2 (solid line) and of the waveguide antenna from FIG. 1 (dashed line) [frequency 78.5 GHZ; φ=90°];

FIG. 9A shows a simplified schematic representation of a further embodiment of a waveguide antenna according to the present disclosure in a top view and as viewed in the cross-section along section A-A (H-plane) and section C-C (E-plane);

FIG. 9B shows a simplified schematic representation of the waveguide antenna from FIG. 9A in a side view and of the radiator elements in a top view along section B-B;

FIG. 10 shows a simplified schematic representation of a further embodiment of a waveguide antenna according to the present disclosure in a top view (left) and in a side view, and of the radiator elements which are arranged such that the central axes thereof are arranged along a curved line, in a top view along section B-B, and

FIG. 11 shows a simplified representation of an embodiment of a vehicle according to the present disclosure.

### DETAILED DESCRIPTION

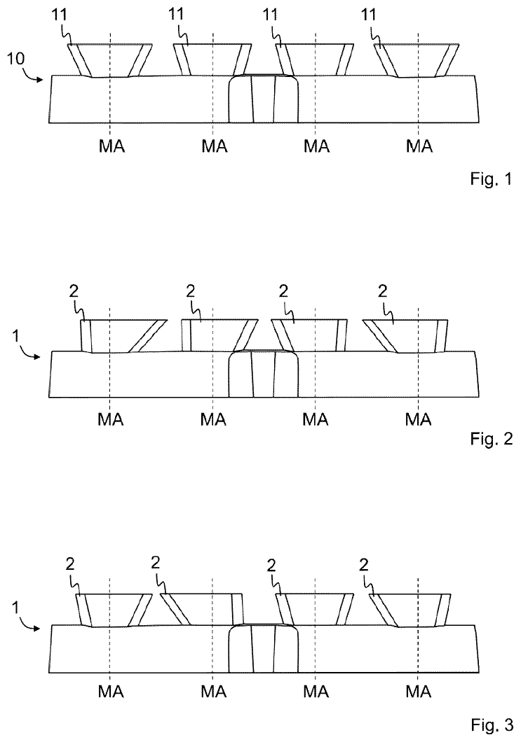

A waveguide antenna 10 for a radar sensor according to the prior art is depicted as viewed in the cross-section of the H-plane in FIG. 1. The waveguide antenna 10 includes four slot radiator or radiator elements 11 which are arranged in a row. The four radiator elements 11 each has a symmetrical opening slope of the four slot radiators. Furthermore, MA denotes the center line which in each case depicts the axis lying in the center of the radiator element 11 or the axis of symmetry around which the body or the wall of the radiator element 11 is rotationally symmetrical with the angle of rotation 180°.

A waveguide antenna 1 according to the present disclosure for a radar sensor as viewed in the cross-section of the H-plane is depicted in FIG. 2. The waveguide antenna 1 includes four slot radiators or radiator elements 2 which are arranged in a row. In this case, the radiator elements 2 have a pyramidally widening form which has a rectangular footprint. Alternatively, the radiator can also have a straight design (without widening) or can, e.g., widen conically or in another way. In addition, the footprint can also include another form, e.g., round, square or a different polygonal form. Furthermore, another number of single radiators or radiator elements can also be provided, but at least two. The waveguide 1 is fed centrally, wherein the horizontal waveguide in this representation is sinusoidal. However, another type of feed can also be effected such as, for example, end-fed or via a distribution network (“power divider”), since the concept is, as far as possible, independent of the type of feed of the single radiators and the type of waveguide.

Unlike the embodiment in accordance with FIG. 1, the four upper slots of the radiator elements 2 are tilted toward the phase center of the waveguide antenna 1 in FIG. 2. The tilt in FIG. 2 is mirror-symmetrical (i.e., tilted toward the center of the waveguide antenna on both sides of the center of the waveguide antenna), but this can also be adjusted separately for each single radiator or radiator element 2, i.e., with a different tilt, in order to achieve a further improvement, as shown in FIG. 3.

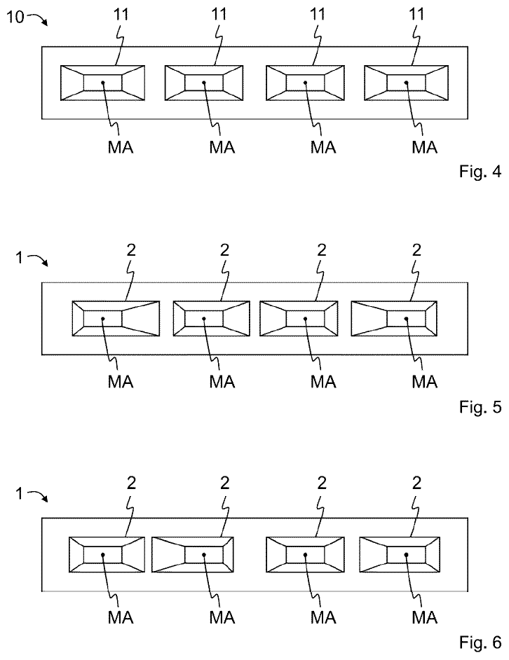

A top view of the waveguide antenna 10 from FIG. 1 according to the prior art is shown in FIG. 4, wherein the radiator elements 11 are rotationally symmetrical with an angle of rotation of 180°. Top views of the waveguide antennas 1 of FIG. 2 and FIG. 3 are shown in FIG. 5 and FIG. 6. In this case, at least one of the radiator elements 2 is only symmetrical with respect to rotations of 360° in a top view, i.e., not rotationally symmetrical relative to the original central axis MA, wherein the walls of the non-rotationally symmetrical radiator elements 2 are tilted relative to the original central axis MA or center line of the radiator element 2, i.e., in this case, the radiator element 2 is in each case tilted toward the phase center of the waveguide antenna 1. The tilted radiator element 2 is no longer rotationally symmetrical due to the tilt relative to the original central axis MA (in particular in a top view). The tilting according to the present disclosure of the radiator elements 2 results in a higher signal-to-noise ratio since the gain is reduced at higher elevation angles. The central axes MA of the radiator elements are arranged on a straight line in FIG. 5 and FIG. 6.

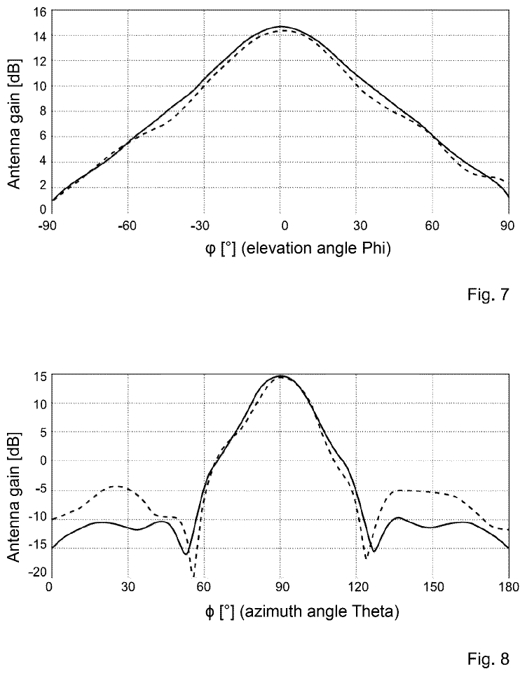

The resulting antenna gain in elevation and azimuth of the waveguide antenna 1 from FIG. 2 (solid line) and of the waveguide antenna 10 from FIG. 1 (dashed line) is depicted in FIG. 7 and FIG. 8, as a result of which it is made clear how the effect of the tilting of the radiator elements 2 operates and the side lobes can be reduced to a particular extent, as in FIG. 8, on the basis of the comparison between waveguide antenna 1 and waveguide antenna 10.

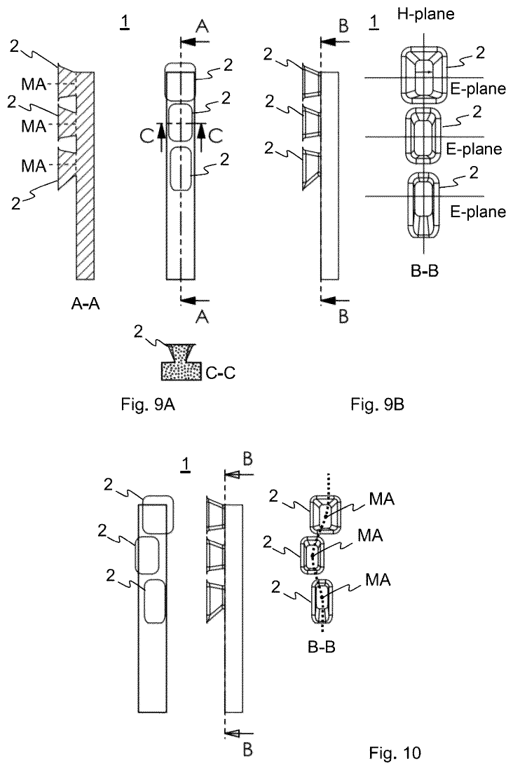

A further embodiment according to the present disclosure having three radiator elements 2 is shown in FIG. 9A and FIG. 9B, wherein FIG. 9A shows a top view (top right), which illustrates the arrangement of the individual radiator elements 2. The cross-section along section A-A (top left) shows the cross-section of the H-plane and the cross-section along section C-C (bottom right) shows the cross-section of the E-plane through one of the radiator elements 2. In this case, it can be clearly seen that the radiator elements 2 are asymmetrical as viewed in the cross-section of the H-plane, i.e., that one wall of the radiator element 2 is tilted compared to the opposite wall of the radiator element 2, whilst there is no tilt in the cross-section of the E-plane. In the same way, this is also shown in the side view, as shown in FIG. 9B, section B-B (left) and the top view of the radiator elements 2 along section B-B (right). The central axes MA of the individual radiator elements 2 are expediently arranged along a straight line which corresponds, e.g., to the line A-A in the top view, FIG. 9A (right), or the line B-B in the top view, FIG. 9B (right).

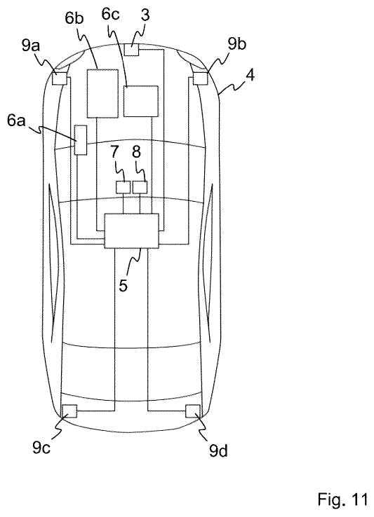

Furthermore, a further embodiment of the waveguide antenna according to the present disclosure having three radiator elements 2 is shown in FIG. 10, wherein the radiator elements 2 are arranged laterally offset with respect to one another in such a way that the central axes MA thereof are arranged along a curved line (indicated by dotted lines).

A vehicle 4 according to the present disclosure is shown in FIG. 11, which has a radar sensor 3 according to the present disclosure. Reference numeral 5 in FIG. 11 denotes a control device (ECU, Electronic Control Unit or ADCU, Assisted and Automated Driving Control Unit), by which a sensor control, sensor data fusion, environment and/or object recognition, trajectory planning and/or vehicle control can take place, in particular (partially) autonomously. To control the vehicle, the control device 5 can have recourse to various actuators (steering 6a, engine 6b, brake 6c). Furthermore, the vehicle 1, in addition to the radar sensor 3, has further sensors (lidar sensor 7, camera 8 as well as ultrasonic sensors 9a-9d) for capturing the environment. The sensor data can be advantageously utilized for recognizing the environment and objects so that various assistance functions such as, e.g., Emergency Brake Assist (EBA), Adaptive Cruise Control (ACC), a Lane Departure Warning System or a Lane Keep Assist (LKA) or the like can be realized. Furthermore, the assistance functions can likewise be executed via the control device 5 or another control unit provided for this purpose.

In summary, the present disclosure discloses a waveguide arrangement or a waveguide antenna which consists of a plurality of slots which are fed by an underlying waveguide structure (which can be, e.g., a rectangular waveguide, a ridge waveguide or an EBG waveguide), which are connected to a plurality of radiator elements or horns or multiple open waveguide antennas. In this case, the individual slots can be of different sizes and can either be aligned on a single line or laterally displaced with respect to one another. The X and Y dimensions of the individual slots can approximate one another to a limited extent by not changing or jeopardizing the polarization of the antenna. In this case, the horns/antennas having an open waveguide are symmetrical in the E-plane (E-plane is the plane parallel to the electric field), whilst they are asymmetrical in the H-plane (H-plane is the plane parallel to the H-field). Furthermore, the respective H-planes of the slots or radiator elements can lie on the same plane or on a plurality of planes which are substantially parallel to one another, which can have a very advantageous effect on the antenna gain.

### LIST OF REFERENCE NUMERALS

1 Waveguide antenna
2 Radiator element
3 Radar Sensor
4 Vehicle
5 Control device
6a Steering
6b Engine
6c Brake
7 Lidar sensor
8 Camera
9a-9d Ultrasonic sensor
10 Waveguide antenna (prior art)
11 Radiator element
MA Central axis

1. A waveguide antenna for a radar sensor, comprising:
at least two adjacent radiator elements for at least one of transmitting and/or receiving signals, wherein
each radiator element has a surrounding wall that forms a cavity, and a central axis of the radiator element extends through the cavity, and the surrounding wall of at least one of the radiator elements is tilted relative to the central axis of the radiator element as viewed in a cross-section of an H-plane.

2. The waveguide antenna according to claim 1, wherein the waveguide antenna is a slot antenna or a horn antenna or an open ended wave guide (OEWG) antenna.

3. The waveguide antenna according to claim 1, wherein the radiator elements are tilted symmetrically; relative to a center of the waveguide antenna as viewed in the cross-section of the H-plane.

4. The waveguide antenna according to claim 3, wherein the radiator elements are tilted toward the center of the waveguide antenna on both sides of the center of the waveguide antenna or away from the center of the waveguide antenna on both sides of the center of the waveguide antenna as viewed in the cross-section of the H-plane.

5. The waveguide antenna according to claims 1, wherein tilted radiator elements are tilted in the same direction as viewed in the cross-section of the H-plane.

6. The waveguide antenna according to claim 1, tilted radiator elements are tilted at the same tilt angle.

7. The waveguide antenna according to claims 1, wherein the radiator elements have a widening form.

8. The waveguide antenna according to claim 1, the radiator elements are arranged such that the central axes thereof are arranged along a curved line.

9. A radar sensor in particular for recognizing objects vehicle, having a high-frequency (HF) component for generating/receiving HF signals and at least one opening for at least one of coupling in and/or coupling out the HF signals, having a waveguide antenna according to claim 1.

10. A vehicle, having a radar sensor according to claim 9.

11. The waveguide antenna according to claim 3, wherein the tilted radiator elements are tilted mirror symmetrically relative to the center of the waveguide antenna as viewed in the cross-section of the H-plane.

12. The waveguide antenna according to claim 7, wherein the widening form of the radiator elements comprises at least one of a conically widening form or a pyramidally widening form.

13. The waveguide antenna according to claim 8, wherein the curved line comprises a serpentine line.
